(19) United States
(12) Patent Application Publication
(10) Pub. No.: US 2018/0089624 A1
(43) Pub. Date: Mar. 29, 2018

(54) THREE DIMENSIONAL LOADING SYSTEM AND METHOD

(71) Applicant: Rivigo Services Private Limited, Gurugram (IN)

(72) Inventor: Hemant KHANDELWAL, Bangalore (IN)

(21) Appl. No.: 15/683,656

(22) Filed: Aug. 22, 2017

(30) Foreign Application Priority Data
Sep. 23, 2016 (IN) 201611032602

(51) Int. Cl. G06Q 10/08; B65G 67/04

(52) U.S. Cl. CPC G06Q 10/08355; B65G 67/04

(57) ABSTRACT

The present disclosure provides a system for a 3-dimensional loading system for loading a plurality of packages in one or more vehicles. The 3-dimensional loading system includes a first step of receiving a first set of data. In addition, the 3-dimensional loading system includes another step of collecting a second set of data. Further, the 3-dimensional loading system includes yet another step of obtaining a third set of data. Furthermore, the 3-dimensional loading system includes yet another step of analyzing the first set of data, the second set of data and the third set of data. The 3-dimensional loading system includes yet another step of profiling the plurality of packages. The 3-dimensional loading system includes yet another step of creating a layering plan. The 3-dimensional loading system includes yet another step of loading. The 3-dimensional loading system includes yet another step of unloading.

### TECHNICAL FIELD

The present disclosure relates to a field of logistics system. More specifically, the present disclosure relates to a method and system for loading packages in vehicle.

### BACKGROUND

Business enterprises consistently need to transport goods and packages from loading stations to various customer premises in a logistics network. Loading trucks pick up goods and packages from a specific point and multiple intermediate locations on their way to a final destination. The packages are loaded and unloaded at multiple locations before reaching its final destination. Each loading truck has a pre-defined storage capacity inside which a fixed amount of packages can be stored. The storage capacity of the loading trucks changes as the packages are unloaded and loaded from one truck to another truck at intermediate locations. Typically, a pickup truck picks up packages from multiple client locations and transports the packages to an intermediate location where trucks from multiple locations arrive. Accordingly, the packages from all the trucks are loaded to a truck with much larger capacity. Typically, the continuous loading and unloading of packages takes a toll on the packages. The loading and unloading of packages damages the packages if the loading and unloading is done improperly. In addition, it is possible that heavier packages are placed over light weighing packages or packages which have to be delivered prior to other packages are placed far away inside the trucks. This leads to further damage to the packages which in turn leads to customer dissatisfaction and loss of revenue to the logistics organization.

### SUMMARY

In a first example, a computer-implemented method is provided. The computer-implemented method is for a 3-dimensional loading system for loading a plurality of packages in one or more vehicles. The computer-implemented method may include a first step of receiving a first set of data associated with the plurality of packages in real time present in the one or more built environments. In addition, the computer-implemented method may include a second step of collection of a second set of data associated with the one or more vehicles present inside each of the one or more built environments. Moreover, the computer-implemented method may include a third step of obtaining a third set of data associated with each of a delivery plan of the plurality of packages associated with one or more. Further, the computer-implemented method may include a fourth step of analyzing the first set of data associated with the plurality of packages, the second set of data associated with the one more vehicle and the third set of data associated with the delivery plan of the plurality of packages received. Furthermore, the computer-implemented method may include a fifth step of profiling the plurality of packages received from the one or more sources. Also, the computer-implemented method may include a sixth step of creating a layering plan for each vehicle of the one or more vehicles to optimize the storage capacity of each vehicle of the one or more vehicles, wherein the layering plan being created based on the delivery plan of the plurality of packages. In addition, the computer-implemented method may include a seventh step of loading the plurality of packages received from the one or more sources in the one or more vehicles. Also, the computer-implemented method may include an eighth step of unloading the plurality of packages from the one or more vehicles at the one or more destinations. The plurality of packages may be associated with the one or more sources. Each vehicle of the plurality of vehicles may include a storage capacity. The analysis may be done to optimize the 3-dimensional loading system to ensure routing of the plurality of packages from the one or more source to the one or more destinations without damage. The profiling of the plurality of packages may be done to sort the plurality of packages. Further the profiling of the plurality of packages may be done based on analysis of the first set of data, the second set of data and the third set of data. The layering plan may be created based on the delivery plan of the plurality of packages. The loading of the plurality of packages may be performed based on the layering plan of each package of the plurality of packages. The unloading of the plurality of packages may be based on the delivery plan.

In an embodiment of present disclosure, the computer-implemented method may include the first set of data. The first set of data may include one or more characteristics of each package of the plurality of packages. The one or more characteristics of each package of the packages may include content inside each package of the plurality of packages, geometrical structure of each package of the plurality of packages, weight of each package of the plurality packages and type of material of each package of the plurality of packages.

In an embodiment of present disclosure, the computer-implemented method may include assignment of a unique identification tag to each package of the plurality of packages. The unique identification tag may include the one or more characteristics of the plurality of packages.

In an embodiment of present disclosure, the computer-implemented method may include scanning of the unique identification tag of each package of the plurality of packages. The scanning may be done to validate desired loading of each package of the plurality of packages.

In an embodiment of present disclosure, the computer-implemented method may include broadcasting of an alert notification on one or more display devices associated with one or more loaders. The alert notification may be broadcasted in real time.

In an embodiment of present disclosure, the computer-implemented method may include the second set of data. The second set of data associated with the one or more vehicles may include the storage capacity of each vehicle of the one or more vehicles, strength of each vehicle of the one or more vehicles and size of each vehicle of the one or more vehicles.

In an embodiment of present disclosure, the computer-implemented method may include optimization of the third set of data associated with delivery plan of the plurality of packages by a route plan and a network plan. The route plan may optimize travel distance based on plurality of parameters. The plurality of parameter may include geo-location of route, traffic data of the route, time of the day and behavior of the route. The network plan may optimize number of the loading and the unloading of each package of the plurality of packages.

In an embodiment of present disclosure, the computer-implemented method may include creation of the layering plan for each vehicle of the plurality of vehicles. The creation of the layering plan for each vehicle of the plurality of vehicles may be done by grouping the plurality of packages of similar characteristics together. The layering plan may be created by performing multiple permutations and combinations.

In an embodiment of present disclosure, the computer-implemented method may include storage of the first set of data, the second set of data, the third set of data, the delivery plan and the layering plan. The storage may be done in real time.

In an embodiment of present disclosure, the computer-implemented method may include updating of the first set of data, the second set of data, the third set of data, the delivery plan and the layering plan. The updating may be done in real time.

In a second example, a computer system is provided. The computer system may include one or more processors and a memory coupled to the one or more processors. The memory may store instructions which, when executed by the one or more processors, may cause the one or more processors to perform a method. The method is a 3-dimensional loading system for loading a plurality of packages in one or more vehicles. The method may include a first step of receiving a first set of data associated with the plurality of packages in real time present in the one or more built environments. In addition, the method may include a second step of collection of a second set of data associated with the one or more vehicles in real time present inside each of the one or more built environments. Moreover, the method may include a third step of obtaining a third set of data associated with each of a delivery plan of the plurality of packages associated with one or more. Further, the method may include a fourth step of analyzing the first set of data associated with the plurality of packages, the second set of data associated with the one more vehicle and the third set of data associated with the delivery plan of the plurality of packages received. Furthermore, the method may include a fifth step of profiling the plurality of packages received from the one or more sources. Also, the method may include a sixth step of creating a layering plan for each vehicle of the one or more vehicles to optimize the storage capacity of each vehicle of the one or more vehicles, wherein the layering plan being created based on the delivery plan of the plurality of packages. In addition, the method may include a seventh step of loading the plurality of packages received from the one or more sources in the one or more vehicles. Also, the method may include an eighth step of unloading the plurality of packages from the one or more vehicles at the one or more destinations. The plurality of packages may be associated with the one or more sources. Each vehicle of the plurality of vehicles may include a storage capacity. The analysis may be done to optimize the 3-dimensional loading system to ensure routing of the plurality of packages from the one or more source to the one or more destinations without damage. The profiling of the plurality of packages may be done to sort the plurality of packages. Further the profiling of the plurality of packages may be done based on analysis of the first set of data, the second set of data and the third set of data. The layering plan may be created based on the delivery plan of the plurality of packages. The loading of the plurality of packages may be performed based on the layering plan of each package of the plurality of packages. The unloading of the plurality of packages may be based on the delivery plan.

In an embodiment of present disclosure, the method may include the first set of data. The first set of data may include one or more characteristics of each package of the plurality of packages. The one or more characteristics of each package of the packages may include content inside each package of the plurality of packages, geometrical structure of each package of the plurality of packages, weight of each package of the plurality packages and type of material of each package of the plurality of packages.

In an embodiment of present disclosure, the method may include assignment of a unique identification tag to each package of the plurality of packages. The unique identification tag may include the one or more characteristics of the plurality of packages.

In an embodiment of present disclosure, the computer-implemented method may include scanning of the unique identification tag of each package of the plurality of packages. The scanning may be done to validate desired loading of each package of the plurality of packages.

In an embodiment of present disclosure, the method may include broadcasting of an alert notification on one or more display devices associated with one or more loaders. The alert notification may be broadcasted in real time.

In an embodiment of present disclosure, the method may include the second set of data. The second set of data associated with the one or more vehicles may include the storage capacity of each vehicle of the one or more vehicles, strength of each vehicle of the one or more vehicles and size of each vehicle of the one or more vehicles.

In an embodiment of present disclosure, the computer-implemented method may include optimization of the third set of data associated with delivery plan of the plurality of packages by a route plan and a network plan. The route plan may optimize travel distance based on plurality of parameters. The plurality of parameter may include geo-location of route, traffic data of the route, time of the day and behavior of the route. The network plan may optimize number of the loading and the unloading of each package of the plurality of packages.

In an embodiment of present disclosure, the method may include creation of the layering plan for each vehicle of the plurality of vehicles. The creation of the layering plan for each vehicle of the plurality of vehicles may be done by grouping the plurality of packages of similar characteristics together. The layering plan may be created by performing multiple permutations and combinations.

In an embodiment of present disclosure, the method may include storage of the first set of data, the second set of data, the third set of data, the delivery plan and the layering plan. The storage may be done in real time.

In an embodiment of present disclosure, the method may include updating of the first set of data, the second set of data, the third set of data, the delivery plan and the layering plan. The updating may be done in real time.

In a third example, a computer-readable storage medium is provided. The computer-readable storage medium encodes computer executable instructions that, when executed by at least one processor, performs a method. The method is for a 3-dimensional loading system for loading a plurality of packages in one or more vehicles. The method may include a first step of receiving a first set of data associated with the plurality of packages in real time present in the one or more built environments. In addition, the method may include a second step of collection of a second set of data associated with the one or more vehicles in real time present inside each of the one or more built environments. Moreover, the method may include a third step of obtaining a third set of data associated with each of a delivery plan of the plurality of packages associated with one or more. Further, the method may include a fourth step of analyzing the first set of data associated with the plurality of packages, the second set of data associated with the one more vehicle and the third set of data associated with the delivery plan of the plurality of packages received. Furthermore, the method may include a fifth step of profiling the plurality of packages received from the one or more sources. Also, the method may include a sixth step of creating a layering plan for each vehicle of the one or more vehicles to optimize the storage capacity of each vehicle of the one or more vehicles, wherein the layering plan being created based on the delivery plan of the plurality of packages. In addition, the method may include a seventh step of loading the plurality of packages received from the one or more sources in the one or more vehicles. Also, the method may include a eighth step of unloading the plurality of packages from the one or more vehicles at the one or more destinations. The plurality of packages may be associated with the one or more sources. Each vehicle of the plurality of vehicles may include a storage capacity. The analysis may be done to optimize the 3-dimensional loading system to ensure routing of the plurality of packages from the one or more source to the one or more destinations without damage. The profiling of the plurality of packages may be done to sort the plurality of packages. Further the profiling of the plurality of packages may be done based on analysis of the first set of data, the second set of data and the third set of data. The layering plan may be created based on the delivery plan of the plurality of packages. The loading of the plurality of packages may be performed based on the layering plan of each package of the plurality of packages. The unloading of the plurality of packages may be based on the delivery plan.

### BRIEF DESCRIPTION OF FIGURES

Having thus described the invention in general terms, reference will now be made to the accompanying drawings, which are not necessarily drawn to scale, and wherein:

FIG. 1 illustrates an interactive computing environment for a 3-dimensional loading system, in accordance with various embodiments of the present disclosure;

FIG. 2 illustrates a block diagram of an interactive computing environment for the 3-dimensional loading system, in accordance with various embodiments of the present disclosure;

FIG. 3 illustrates a block diagram of an interactive computing environment for the 3-dimensional loading system, in accordance with various embodiments of the present disclosure;

FIG. 4 illustrates a flow chart of a method for loading and un-loading a plurality of packages in a vehicle, in accordance with various embodiments of the present disclosure; and

FIG. 5 illustrates a block diagram of a computing device, in accordance with various embodiments of the present disclosure.

It should be noted that the accompanying figures are intended to present illustrations of exemplary embodiments of the present invention. These figures are not intended to limit the scope of the present invention. It should also be noted that accompanying figures are not necessarily drawn to scale.

### DETAILED DESCRIPTION

Reference will now be made in detail to selected embodiments of the present invention in conjunction with accompanying figures. The embodiments described herein are not intended to limit the scope of the invention, and the present invention should not be construed as limited to the embodiments described. This invention may be embodied in different forms without departing from the scope and spirit of the invention. It should be understood that the accompanying figures are intended and provided to illustrate embodiments of the invention described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

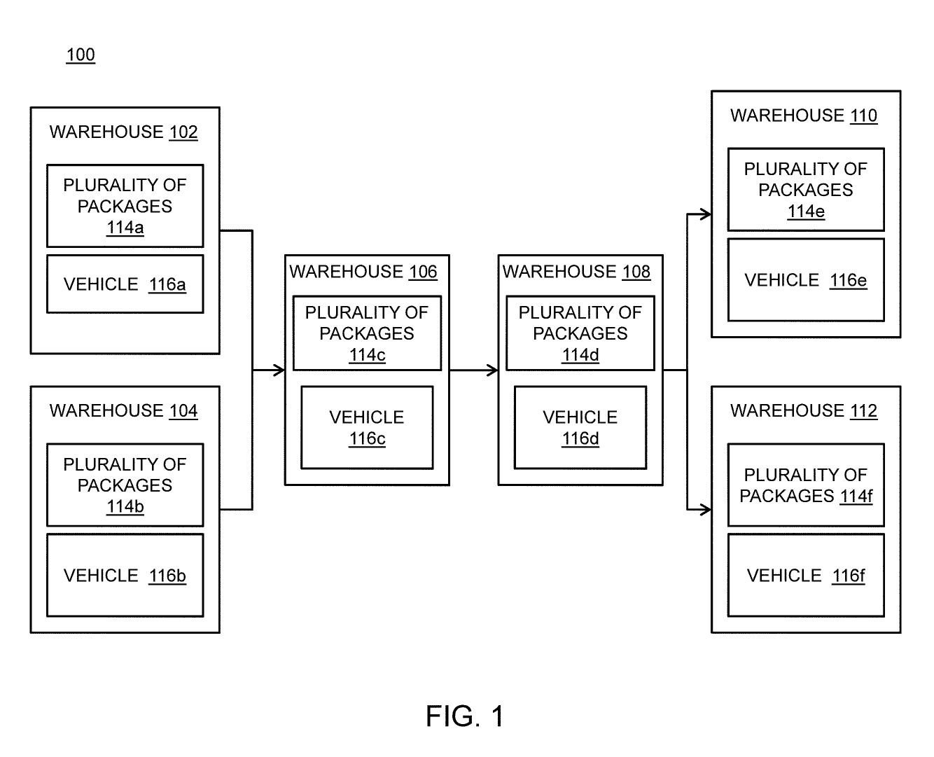

FIG. 1 illustrates an interactive computing environment for a 3-dimensional loading system, in accordance with various embodiments of the present disclosure. The plurality of packages is transported from one or more sources to one or more destinations. The interactive computing environment 100 shows a plurality of system elements for 3-dimensional loading system in real time.

The interactive computing environment 100 includes a warehouse 102, a warehouse 104, a warehouse 106, a warehouse 108, a warehouse 110 and a warehouse 112. In an embodiment the warehouses 102-112 are used for storing goods for daily sales. Further, the warehouses 102-112 are used in factories for storing stock materials and manufactured products for retailing. Furthermore the warehouses 102-112 are used for temporary storage of import or export goods. Moreover the warehouses 102-110 may be located in an industrial area, a factory area and the like. In addition, the warehouse 102 includes the plurality of packages 114a and vehicle 116a. The warehouse 104 includes the plurality of packages 114b and vehicle 116b. Further the warehouse 106 includes plurality of packages 114c and vehicle 116c and the warehouse 108 includes plurality of packages 114d and vehicle 116d. Moreover the warehouse 110 includes plurality of packages 114e and vehicle 116e. In addition, the warehouse 112 includes plurality of packages 114f and vehicle 116f.

In an embodiment of present disclosure, the plurality of packages 114a-114f is transported by the plurality vehicles 116a-116e. In an example, the plurality of packages 114a-114f includes one or more electronic units such as televisions, mobile phones, washing machines, refrigerators, air conditioners, speakers and the like. In another example, the plurality of packages 114a-114f includes one or more mechanical units such as lathe machines, mechanical tools, wheels, vehicles and the like. In another example, the plurality of packages 114a-114f includes one or more electrical units such as cables, wires, transformers, switches, plugs, switch boards, batteries, inverters and the like. In another example, the plurality of packages 114a-114f includes one or more chemical and plastic units such as buckets, oil, brush, Tiffin box, cosmetics, plastic chairs and the like. In another example, the plurality of packages 114a-114f includes one or more food items such as fruits, vegetables, tea, chips, juice, pulse, wheat, grain, and the like.

The one or more warehouse 102-112 includes the plurality of vehicles 116a-116f to transport the plurality of packages 116a-116f. In general, the plurality of vehicles 116a-116f used for transporting peoples, goods from one place to another place are of different type and size. In an embodiment of the present disclosure, the plurality of vehicles 116a-116f include the vehicles having at least four wheels such as trucks, buses, tractors, van, cars and the like. Each of the plurality of vehicles 116a-116f is different from others in shape, size, type, capacity, and strength. In an example, the one or more trucks are of different types and sizes with different capacities. The one or more trucks include semi-trailer truck, jumbo trailer truck, tail-lift truck, straight truck and the like. In an example, the semi-trailer truck and jumbo trailer truck have the capacity of about 24,000 kg. In another embodiment of the present disclosure, the plurality of vehicles 116a-116f include the vehicles having less than four wheels such as auto, rickshaw which are used for the transportation of a particular number of goods. Further the vehicles 116a-116f may include plurality of characteristics. The plurality of characteristics may include storage capacity of the vehicles 116a-116f, strength of the vehicles 116a-116f and size of the vehicles 116a-116f.

In an example, the warehouse 102 and the warehouse 104 are sources for the plurality of packages 114a-114b. The warehouse 102 includes the vehicle 116a and the warehouse 104 includes the vehicle 116b. Further the vehicles 116a-116b are trucks with small capacity. Further the vehicle 116a is loaded with the plurality of packages 114a from the warehouse 102 and the vehicle 116b loaded with the plurality of packages 114b from the warehouse 104. Moreover the warehouse 106 is destination for the plurality of packages 114a-114b from the warehouses 102-104. The warehouse 106 includes the vehicle 116c. The vehicle 116c is a truck with large capacity. The plurality of packages 114a-114b from the warehouse 102-104 is unloaded from the vehicles 116a-116b at the warehouse 106. Further the vehicle 114c is loaded with the plurality of packages 114a-114b. Furthermore the warehouse 106 is the source and the warehouse 108 is the destination for the plurality of packages 114a-114b. Furthermore, the warehouse 108 includes the vehicle 116d. The vehicle 116d is the truck with large capacity. Moreover the plurality of packages 114a-114b from the warehouse 106 is unloaded from the vehicle 116c. The vehicle 116d is loaded with the plurality of packages 114a-114b. Further, the warehouse 108 is the source and the warehouses 110-112 is final destination for the plurality of packages 114a-114b. In addition the warehouse 110 includes the vehicle 116e and the warehouse 112 may include the vehicle 116f. Further the vehicles 116e-116f is the trucks with small capacity. Furthermore the plurality of packages 114a-114b from the warehouse 108 is unloaded from the vehicle 116d. The plurality of packages is received at the warehouses 110-112.

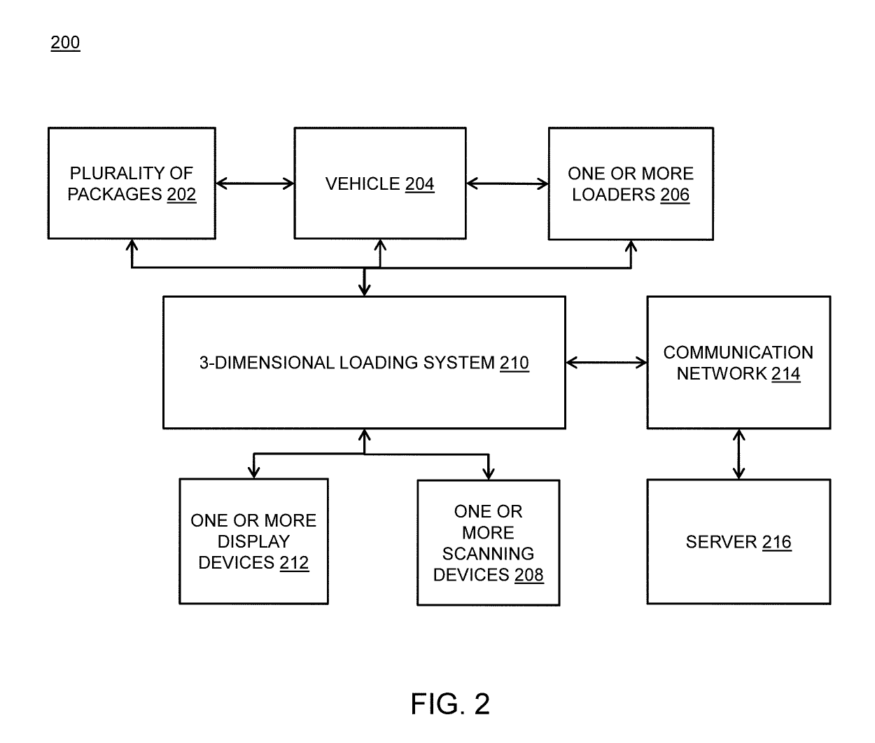

FIG. 2 illustrates a block diagram of an interactive computing environment for the 3-dimensional loading system, in accordance with various embodiments of the present disclosure. It may be noted that to explain the system elements of FIG. 2, references will be made to the system elements of FIG. 1. The block diagram 200 depicts the system architecture of the 3-dimensional loading system 210. The system architecture of the 3-dimensional loading system 210 may include a plurality of components. The plurality of components collectively performs the monitoring and control of the performance of the one or more software applications.

The plurality of components of the interactive computing environment system includes a plurality of packages 202, a vehicle 204, one or more loaders 206, and one or more scanning devices 208. Further the plurality of components of the interactive computing environment includes the 3-dimensional loading system 210, one or more display devices 212, a communication network 214 and a server 216.

In an embodiment of present disclosure, the interactive computing environment includes the plurality of packages 202 to be transported from one or more sources to one or more destinations. In an example, the plurality of packages 202 includes one or more electronic units such as televisions, mobile phones, washing machines, refrigerators, air conditioners, speakers and the like. In another example, the plurality of packages 202 includes one or more mechanical units such as lathe machines, mechanical tools, wheels, vehicles and the like. In another example, the plurality of packages 202 includes one or more electrical units such as cables, wires, transformers, switches, plugs, switch boards, batteries, inverters and the like. In another example, the plurality of packages 202 includes one or more chemical and plastic units such as buckets, oil, brush, Tiffin box, cosmetics, plastic chairs and the like. In another example, the plurality of packages 202 includes one or more food items such as fruits, vegetables, tea, chips, juice, pulse, wheat, grain, and the like. In an embodiment of present disclosure, each package of the plurality of packages 202 is assigned a unique identification tag. The unique identification tag includes the plurality of characteristics of each package of the plurality of packages 202. In an embodiment of present disclosure, the unique identification tag is a Barcode. In another embodiment, the unique identification tag is a Radio Frequency Identification (RFID). In yet another embodiment, the unique identification tag is any unique code to provide the plurality of characteristics of each package of the plurality of packages 202. Further each package of the plurality of packages 202 is modeled based on one or more parameters. In addition, the one or more parameters include invoice, image, material, user inputs used in multiple calculations on the layout plan and the like. Moreover the plurality of packages 202 is loaded on the vehicle 204.

In an embodiment of present disclosure, the interactive computing environment includes the vehicle 204 to transport the plurality of packages 202 from the one or more source to the one or more destination. In general, the vehicle 204 is used for transporting people, goods from one place to another place are of different type and size. In an embodiment of the present disclosure, the vehicle 204 include vehicle having at least four wheels such as trucks, buses, tractors, van, cars and the like. The vehicle 204 is different from others in shape, size, type, capacity, and strength. In an example, the one or more trucks are of different types and sizes with different capacities. The one or more trucks include semi-trailer truck, jumbo trailer truck, tail-lift truck, straight truck and the like. In an example, the semi-trailer truck and jumbo trailer truck have the capacity of about 24,000 kg. In another embodiment of the present disclosure, the plurality of vehicles 204 include the vehicles having less than four wheels such as auto, rickshaw which are used for the transportation of a particular number of goods. Further, the vehicle 204 includes a plurality of characteristics. The plurality of characteristics of the vehicle 204 includes storage capacity of the vehicle 204, size of the vehicle 204, strength of the vehicle 204 and the like. The plurality of packages 202 is loaded on the vehicle 204 at the one or more sources and the plurality of packages are unloaded from the vehicle 204 at the one or more destinations. Further for the loading and the unloading is performed by the one or more loaders 206.

The one or more loaders 206 perform function of the loading and the unloading of the plurality of packages 202. Further the one or more loaders 206 include one or more operation assistants. The one or more loaders 206 have complete layout of the plurality of packages 202 to be loaded. In an example, the one or more loaders 206 are individual persons. In another example, the one or more loaders 206 are lifting machine such as sideways lifter, tractor, cranes and the like. Further the one or more loaders 206 have complete layout to guide the plurality of packages 202 during scanning process of each package of the plurality of packages 202. Further, the scanning process is performed by the one or more scanning devices 208 associated with one or more loaders 206.

The one or more scanning devices 208 are used for scanning the unique identification tag of each package of the plurality of packages 202. In an embodiment of present disclosure, the one or more scanning devices 208 are Barcode reader for scanning Barcode. In another embodiment of the present disclosure, the one or more scanning devices 208 are pen-type scanners. In yet another embodiment of the present disclosure, the one or more scanning devices 208 are RFID scanners. In yet another embodiment of the present disclosure, the one or more scanning devices 208 are handheld scanners. In yet another embodiment of the present disclosure, the one or more scanning devices 208 are camera. In yet another embodiment of the present disclosure, the one or more scanning devices 208 are laser scanner. The one or more scanning devices 208 are associated with the 3-dimensional loading system 210.

In an embodiment of the present disclosure, the interactive computing environment includes the one or more display devices 212. Further the one or more display devices 212 are used for visual representation of the loading and the unloading of the plurality of packages 202 in real time. In an embodiment of the present disclosure, the one or more display devices 212 are handheld devices. Further the handheld devices include mobile phones, laptop, tablet and the like. In another embodiment of the present disclosure, the one or more display devices 212 are liquid crystal display (LCD). In yet another embodiment of the present disclosure, the one or more display devices 212 are holographic display devices. In yet another embodiment of the present disclosure, the one or more display devices 212 are laser display devices. Further the plurality of packages 202, the vehicle 204, the one or more scanning devices 206 and the one or more display devices 212 are associated with the 3-dimensional loading system 210.

The 3-dimensional loading system 210 is provided to reduce the percentage of damage of the plurality of packages 202 by providing most optimized loading plan. The 3-dimensional loading system 210 receives a first set of data associated with the plurality of packages 202 from the source. The first set of data associated with the plurality of packages 202 is received using a method. In an embodiment of the present disclosure, the method involves digital collection of the first set of data associated with the plurality of packages 202. In another embodiment of the present disclosure, the method involves physical collection of the first set of data associated with the plurality of packages 202. The first set of data associated with the plurality of packages 202 includes a plurality of characteristics. Further the plurality of characteristics includes content of each package of the plurality of packages 202, geometrical structure of each package of the plurality of packages 202. Furthermore, the plurality of characteristics includes weight of each package of the plurality of packages 204, type of material of each package of the plurality of packages 204 and the like.

The 3-dimensional loading system 210 fetches a second set of data associated with the vehicle 204. The collection of the second set of data associated with the vehicle 204 includes the plurality of parameters. The plurality of parameters includes the storage capacity of the vehicle 204, the strength of the vehicle 204, size of the vehicle 204 and the like. In general, the vehicle 204 is used for transporting people, goods from the source to destination. In an example, the vehicle 204 is a truck. The second set of data associated with the truck is size of the tuck, storage capacity of the truck, strength of the truck and the like. In an embodiment of the present disclosure, the second set of data is associated with the vehicle 204. In another embodiment of the present disclosure, the second set of data is associated with one or more vehicles.

In an embodiment of the present disclosure, the plurality of packages 202 is transported from the one or more sources to the one or more destinations involves a delivery plan. Further the 3-dimensional loading system 212 obtains a third set of data associated with the delivery plan of the plurality of packages 202 associated with one or more sources. The third set of data associated with the delivery plan of the plurality of packages 202 includes a route plan and a network plan. Further the route plan uses an algorithm to minimize the travel distance by using one or more parameters. Furthermore the one or more parameters include geo-location data, traffic data, time of the day, behavior of route and the like. Moreover the one or more parameters are used for optimizing the route. In addition, the one or more parameters are calculated by using one or more sensors attached to the vehicle 204. In an embodiment of the present disclosure, the one or more sensors attached to the vehicle 204 are global positioning system (GPS). In another embodiment of the present disclosure, the one or more sensors attached to the vehicle 204 are geo-location sensors as sonar sensors, laser sensors, image sensors and the like. The network plan involves an algorithm to minimize the number of the loading and the unloading of the plurality of packages 202 required to transport. The network plan includes multiple approaches to prepare the most optimized delivery plan. The multiple approaches include cost optimization, availability of the vehicle 204, shipment time and the like.

In an embodiment of the present disclosure, the 3-dimensional loading system 210 includes profiling of the plurality of packages 202. Further the profiling of the plurality of packages 202 is done based on the first set of data, the second set of data and the third set of data. Furthermore the profiling of the plurality of packages 202 is done for sorting the plurality of packages 202.

In an embodiment of the present disclosure, the profiling of the plurality of packages 202 is done based on of the content of each package of the plurality of packages 202. Further the sorting is done based on the profiling of the plurality of packages 202. In an example, the content of each package of the plurality of packages 202 includes mechanical units such as lathe machines, mechanical tools, wheels, vehicles and the like. In another example, the content of each package of the plurality of packages 202 includes electrical units such as cable, wires, transformers, switches, batteries, inverters and the like. In another example, the content of the packages of the plurality of packages 202 includes plastic units such as buckets, brush, plastic chairs and the like. In addition, the profiling is done on the basis of weight of each package of the plurality of packages 202. Moreover for sorting the plurality of packages 202 based on the weight of each package of the plurality of packages 202 is done using weight optimizer. Moreover the weight of each package of the plurality of packages 202 is used by the weight optimizer to produce a gradient and a hierarchical system for sorting the plurality of packages 202. In an example, light weight packages are clustered together and heavy weight packages are clustered together. In addition, the profiling is done based on the delivery plan of each package of the plurality of packages 202. The sorting is done based on the delivery plan of each package of the plurality of packages 202. In an example, one or more packages to be delivered early are clustered together and the one or more packages to be delivered later are clustered together.

In an embodiment of the present disclosure, the 3-dimensional loading system includes creation of a layering plan for the storage capacity of the vehicle 204. The layering plan is used to optimize the storage capacity of the vehicle 204. Further the layering plan of the vehicle 204 is created based on the third set of data associated with the delivery plan of the plurality of packages 202. Moreover the layering plan of the vehicle 204 is prepared for creating a 3-D model for the vehicle 204. The 3-D model of the vehicle 204 represents space occupied and empty space of the storage capacity of the vehicle 204. Furthermore the layering plan uses heuristics to provide real time update to load each package of the plurality of packages 202. The layering plan for the storage capacity of the vehicle 204 is displayed on the one or more display device 212.

In an embodiment of the present disclosure, the 3-dimensional loading system 210 includes loading of each package of the plurality of packages 202 received from the one or more sources. Further the loading of each package of the plurality of packages 202 on the vehicle 204 is done by one or more loaders 206. Moreover the loading of each package of the plurality of packages 202 is done based on the layering plan of the vehicle 204. In an example, the plurality of packages 202 is loaded on the vehicle 204 based on the layering plan. The storage capacity of the vehicle 204 is displayed on the one or more display devices 212. In an example, the empty space is represented by green color and the occupied space is represented by red color. The plurality of packages 202 is loaded based on the delivery plan. A package of the plurality of packages 202 to be delivered at first is loaded at last and a package of the plurality of packages 202 to be delivered at the last is loaded at the first.

In an embodiment of the present disclosure, the 3-dimensional loading system 210 is associated with the one or more scanning devices 208 for scanning the unique identification tag of each package of the plurality of packages 202. Further the one or more scanning devices 208 are associated with the one or more display devices 212. Moreover the one or more scanning devices 208 scan each package of the plurality of packages 202 to be loaded on the vehicle 204. The loading is done based on the layering plan of the vehicle 204. In addition, the one or more scanning devices 208 validate the loading of each package of the plurality of packages 202. Further the one or more scanning devices 208 broadcast alert notification to flag any inappropriate selection of the plurality of packages 202. Furthermore the one or more scanning devices 208 use heuristics and provide real time updates for the deviation from the layering plan. In an example, the plurality of packages 202 includes a package A, a package B, a package C and a package D. The plurality of package 202 is to be loaded on the vehicle 204 corresponding to the layering plan. According to layering plan the package A is to be placed after the package B, the package B is to be placed after the package C and the package C is to be placed after the package D. If any of the plurality of packages is not placed as desired layering plan the alert notification will be broadcasted by the one or more scanning device 208 associated with one or more display devices 212.

In an embodiment of the present disclosure, the 3-dimensional loading system 210 is associated with the server 216 through the communication network 214. The communication network 214 enables the 3-dimensional loading system 210 to gain access to the internet for transmitting data to the server 216. Moreover, the communication network 214 provides a medium to transfer the data between the 3-dimensional loading system 210 and the server 216. Further, the medium for communication may be infrared, microwave, radio frequency (RF) and the like.

In an embodiment of the present disclosure, the 3-dimensional location system 210 is located in the server 216. In another embodiment of the present disclosure, the 3-dimensional loading system 210 is located in any portable communication device. The server 216 handles each operation and task performed by the 3-dimensional loading system 210. The server 216 stores one or more instructions for performing the various operations of the 3-dimensional loading system 210. The 3-dimensional loading system 210 is associated with an administrator 218. The administrator 218 is any person or individual who monitors the working of the 3-dimensional loading system 210. In an embodiment of the present disclosure, the administrator 218 monitors the working of the 3-dimensional loading system 210. The administrator 218 is any person or individual who monitors the working of the 3-dimensional loading system 218 in real time. In an embodiment of the present disclosure, the administrator 218 monitors the working of the 3-dimensional loading system 210 though the one or more display device 212. The one or more display devices 212 include laptops, computers, tablets, and the like.

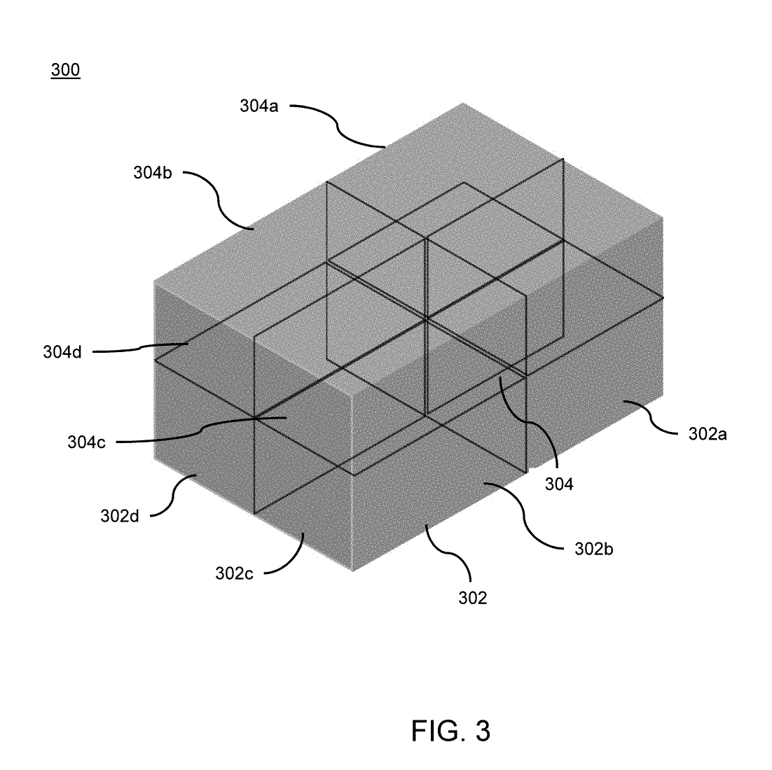

FIG. 3 illustrates a side perspective view 300 of a vehicle for loading plurality of packages associated with layering plan, in accordance with an embodiment of the present disclosure. It may be noted that to explain the system elements of FIG. 3, references will be made to the system elements of FIG. 1 and FIG. 2. The layering plan is used to optimize the storage capacity of the vehicle 204. Further the layering plan of the vehicle 204 is created based on the third set of data associated with the delivery plan of the plurality of packages 202. Moreover the layering plan of the vehicle 204 is prepared for creating a 3-D model for the vehicle 204. The 3-D model of the vehicle 204 represents space occupied and empty space of the storage capacity of the vehicle 204. Furthermore the layering plan uses heuristics to provide real time update to load each package of the plurality of packages 202. In addition, the storage capacity of the vehicle 204 is divided into one or more layers. Further, each layer of the one or more layers is divided into one or more columns. Moreover, each layer of the one or more layers is divided into one or more rows.

In an embodiment of the present disclosure, the one or more horizontal layers include a first layer 302 and a second layer 304. In addition, the first layer 302 is divided into one or more first columns and one or more first rows. The one or more first columns of the first layer 302 include a column 302a and a column 302b. The one or more first rows of the first layer 302 include a row 302c and a row 302d. Further, the second layer 304 is divided into one or more second columns and one or more second rows. The one or more second columns of the second layer 304 include a column 304a and a column 304b. The one or more second rows of the second layer 304 include a row 304c and a row 304d. Further, the plurality of packages 202 is loaded on the vehicle 204 based on the layering plan associated with the delivery plan.

In an example, the plurality of packages 202 includes a package A, a package B, a package C, a package D, a package E, a package F, a package G and a package H. The plurality of packages 202 is loaded on the vehicle 204 based on the layering plan. Further the layering plan is based on the delivery plan. Moreover, the storage capacity of the vehicle is divided into two layers. The two layers include first layer L1 and second layer L2. In addition, each layer of the two layers is divided into two columns and two rows. The first layer L1 includes a first column C1 and a second column C2. Further, the first layer L1 includes a first row R1 and a second row R2. The second layer L2 includes a first column C3 and a second column C4. Furthermore, the second layer L2 includes a first row R3 and a second row R4. In addition, space defined by the second column C2 and the second row R2 of the first layer L1 is near loading entrance. Further, space defined by the second column C2 and the first row R1 of the first layer L1 is near the loading entrance. Furthermore, space defined by the second column C4 and the second row R4 of the second layer L2 is above the space defined by the second column C2 and the second row R2 of the first layer L1. Moreover, space defined by the second column C4 and the first row R3 of the second layer L2 is above the space defined by the second column C2 and the first row R1 of the first layer L1. The package A is to be delivered at last. Moreover, the package A is the heaviest among all the plurality of packages 202. The package B is to be delivered before the package A. Moreover, the package B is lighter than the package A and heavier than the package C, the package D, the package E, the package F, the package G and the package H. The package C is to be delivered before the package A and the package B. Moreover, the package C is lighter than the package A and the package B and heavier than the package D, the package E, the package F, the package G and the package H. The package D is to be delivered before the package A, the package B and the package C. Moreover, the package D is lighter than the package A, the package B and the package C and heavier than the package E, the package F, the package G and the package H. The package E is to be delivered before the package A, the package B, the package C and the package D. Moreover, the package E is lighter than the package A, the package B, the package C and the package D and heavier than the package F, the package G and the package H. The package F is to be delivered before the package A, the package B, the package C, the package D and the package E. Moreover, the package F is lighter than the package A, the package B, the package C, the package D and the package E and heavier than the package G and the package H. The package F is to be delivered before the package A, the package B, the package C, the package D and the package E. Moreover, the package F is lighter than the package A, the package B, the package C, the package D and the package E and heavier than the package G and the package H. The package G is to be delivered before the package A, the package B, the package C, the package D, the package E and the package F. Moreover, the package G is lighter than the package A, the package B, the package C, the package D, the package E and the package F and heavier the package H. The package H is to be delivered at first. Moreover, the package H is lightest among all the plurality of packages 202. Further, the plurality of packages is loaded according to the layering plan based on the delivery plan. The package A is placed at the space defined by the first column C1 and the first row R1 of the first layer L1. The package B is placed at the space defined by the first column C1 and the second row R2 of the first layer L1. The package C is placed at the space defined by the second column C2 and the second row R2 of the first layer L1. The package D is placed at the space defined by the second column C2 and the first row R1 of the first layer L1. The package E is placed at the space defined by the first column C3 and the first row R3 of the second layer L2. The package F is placed at the space defined by the first column C3 and the second row R4 of the second layer L2. The package G is placed at the space defined by the second column C4 and the second row R4 of the second layer L2. The package H is placed at the space defined by the second column C4 and the first row R3 of the second layer L2.

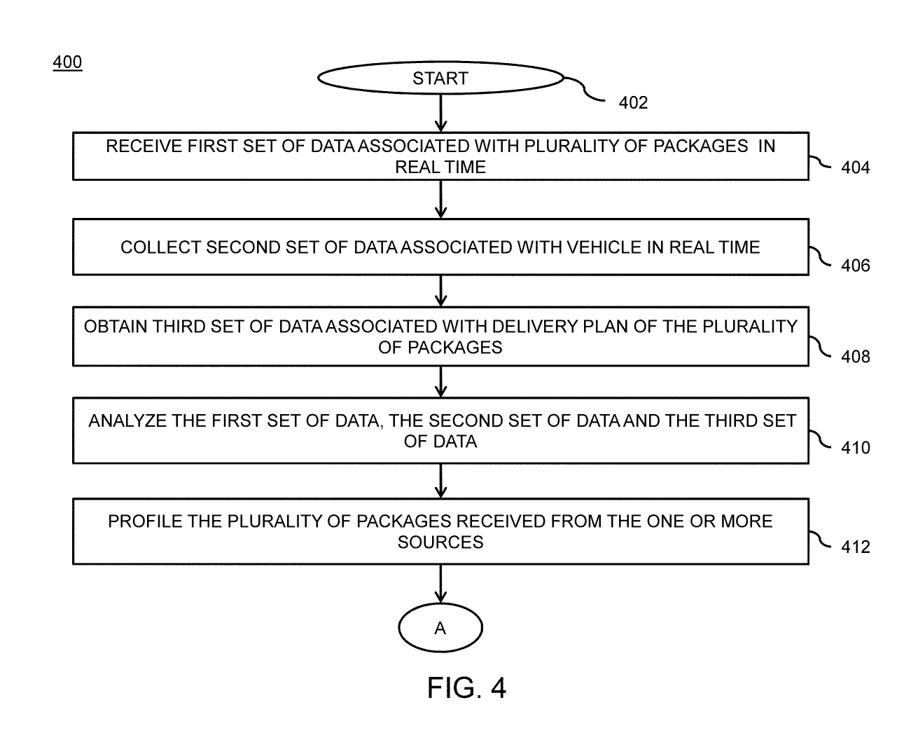

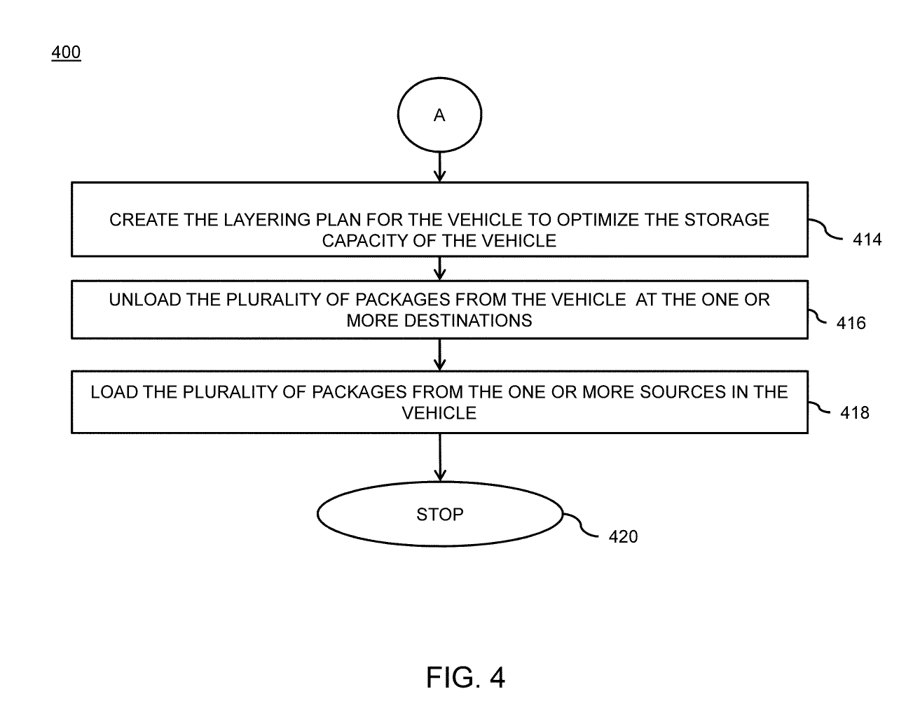

FIG. 4 illustrates a flow chart 400 of a method for loading and un-loading the plurality of packages in a vehicle, in accordance with various embodiments of the present disclosure. It may be noted that to explain the process steps of the flowchart 400, references will be made to the system elements of FIG. 1, FIG. 2, and FIG. 3. It may be noted that the flowchart 400 may have lesser or more number of steps.

The flowchart 400 initiates at step 402. Following step 402, at step 404, the 3-dimensional loading system 210 receives the first set of data associated with the plurality of packages 202 in real time. At step 406, the 3-dimensional loading system 210 collects the second set of data associated with the vehicle 204 in real time. At step 408, the 3-dimensional loading system 210 obtains the third set of data associated with delivery plan of the plurality of packages 202 associated with the one or more sources. At step 410, the 3-dimensional loading system 210 analyzes the first set of data, the second set of data and the third set of data. At step 412, the 3-dimensional loading system 210 profiles the plurality of packages 202 received from the one or more sources. At step 414, the 3-dimensional loading system 210 creates the layering plan for the vehicle 204 to optimize the storage capacity of the vehicle 204. At step 416, the 3-dimensional loading system 210 loads the plurality of packages 202 from the one or more sources in the vehicle 204. At step 418, the 3-dimensional loading system 210 unloads the plurality of packages 202 from the vehicle 204 at the one or more destinations. The flow chart 400 terminates at step 420.

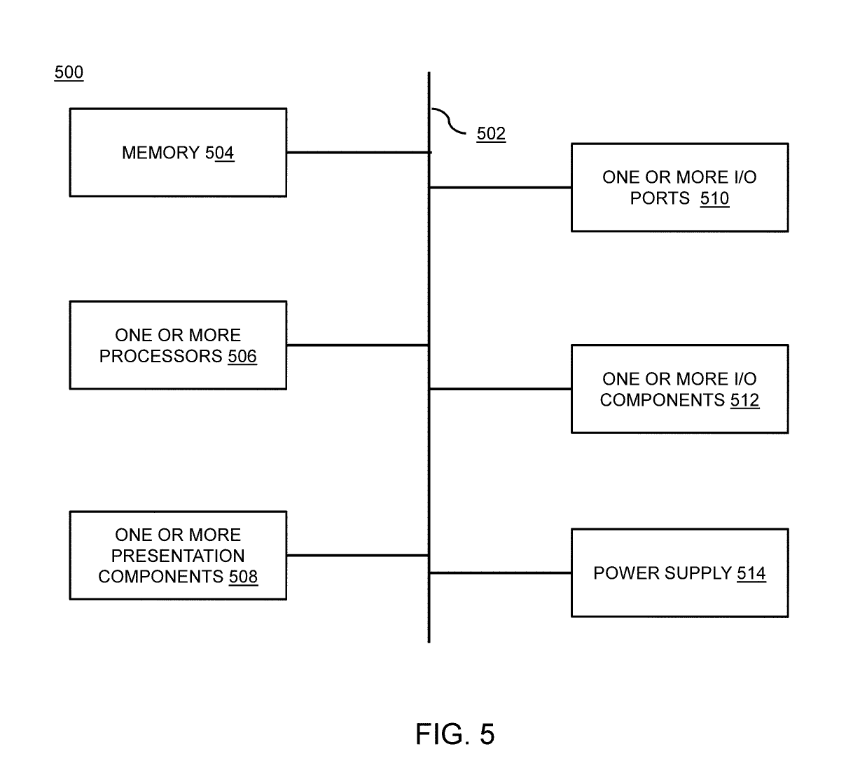

FIG. 5 illustrates a block diagram of a computing device 500, in accordance with various embodiments of the present disclosure. The computing device 500 includes a bus 502 that directly or indirectly couples the following devices: memory 504, one or more processors 506, one or more presentation components 508, one or more input/output (I/O) ports 510, one or more input/output components 512, and an illustrative power supply 514. The bus 502 represents what may be one or more busses (such as an address bus, data bus, or combination thereof). Although the various blocks of FIG. 5 are shown with lines for sake of clarity, in reality, delineating various components is not so clear, and metaphorically, the lines would more accurately be grey and fuzzy. For example, one may consider a presentation component such as a display device to be an I/O component. Also, processors have memory. FIG. 5 is merely illustrative of an exemplary computing device 500 may be used in connection with one or more embodiments of the present disclosure. Distinction is not made between such categories as workstation, server, laptop, hand-held device and the like, as all are contemplated within the scope of FIG. 5 and reference to “the computing device 500.”

The computing device 500 typically includes a computer-readable media. The computer-readable media can be any available media that can be accessed by the computing device 500 and includes both volatile and nonvolatile media, removable and non-removable media. By way of example, and not limitation, the computer-readable media may comprise computer storage media and communication media. The computer storage media includes the volatile and the nonvolatile, the removable and the non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 500. The communication media typically embodies the computer-readable instructions, the data structures, the program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, the communication media includes wired media such as a wired network or direct-wired connection, and wireless media such as acoustic, RF, infrared and other wireless media. Combinations of any of the above should also be included within the scope of the computer readable media.

Memory 504 includes the computer-storage media in the form of volatile and/or nonvolatile memory. The memory 504 may be removable, non-removable, or a combination thereof. Exemplary hardware devices include solid-state memory, hard drives, optical-disc drives and the like. The computing device 500 includes the one or more processors to read data from various entities such as memory 504 or I/O components 512. The one or more presentation components 508 present data indications to a user or other device. Exemplary presentation components include a display device, speaker, printing component, vibrating component and the like. The one or more I/O ports 510 allow the computing device 500 to be logically coupled to other devices including the one or more I/O components 512, some of which may be built in. Illustrative components include a microphone, joystick, game pad, satellite dish, scanner, printer, wireless device and the like.

What is claimed is:

1. A computer-implemented method for a 3-dimensional loading system for loading a plurality of packages in one or more vehicles, the computer-implemented method comprising:
receiving, at a 3-dimensional loading system with a processor, a first set of data associated with the plurality of packages in real time, wherein the plurality of packages is associated with the one or more sources;
collecting, at the 3-dimensional loading system with the processor, a second set of data associated with the one or more vehicles in real time, wherein each vehicle of the one or more vehicles comprising a storage capacity;
obtaining, at the 3-dimensional loading system with the processor, a third set of data associated with delivery plan of the plurality of packages associated with the one or more sources;
analyzing, at the 3-dimensional loading system with the processor, the first set of data associated with the plurality of packages, the second set of data associated with the one more vehicle and the third set of data associated with the delivery plan of the plurality of packages, wherein the analysis being done to optimize the 3-dimensional loading system to ensure routing of the plurality of packages from the one or more sources to the one or more destinations without damage;
profiling, at the 3-dimensional loading system with the processor, the plurality of packages received from the one or more sources, wherein the profiling of the plurality of packages being done to sort the plurality of packages, wherein the profiling of the plurality of packages being done based on analysis of the first set of data, the second set of data and the third set of data;
creating, at the 3-dimensional loading system with the processor, a layering plan for each vehicle of the one or more vehicles to optimize the storage capacity of each vehicle of the one or more vehicles, wherein the layering plan being created based on the delivery plan of the plurality of packages;
loading, at the 3-dimensional loading system with the processor, the plurality of packages received from the one or more sources in the one or more vehicles, wherein the loading of the plurality of packages being performed based on the layering plan for each vehicle of the one or more vehicles; and
unloading, at a 3-dimensional loading system with the processor, the plurality of packages from the one or more vehicles at the one or more destinations, wherein the unloading of the plurality of packages being based on the delivery plan.

2. The computer implemented method as recited in claim 1, wherein the first set of data comprises one or more characteristics of each package of the plurality of packages, wherein the one or more characteristics of each package of the packages incorporate content inside each package of the plurality of packages, geometrical structure of each package of the plurality of packages, weight of each package of the plurality packages and type of material of each package of the plurality of packages.

3. The computer implemented method as recited in claim 1, further comprising assigning, at the 3-dimensional loading system with the processor, a unique identification tag to each package of the plurality of packages wherein the unique identification tag comprises of the one or more characteristics of each package of the plurality of packages.

4. The computer implemented method as recited in claim 1, further comprising scanning, at the 3-dimensional loading system with the processor, the unique identification tag of each package of the plurality of packages, wherein the scanning being done to validate desired loading of each package of the plurality of packages.

5. The computer implemented method as recited in claim 1, further comprising broadcasting, at the 3-dimensional loading system with the processor, an alert notification on one or more display devices associated with one or more loader, wherein the alert notification being broadcasted in real time.

6. The computer implemented method as recited in claim 1, wherein the second set of data associated with the one or more vehicles comprises storage capacity of each vehicle of the one or more vehicles, strength of each vehicle of the one or more vehicles and size of each vehicle of the one or more vehicles.

7. The computer implemented method as recited in claim 1, wherein the third set of data associated with delivery plan of the plurality of packages being optimized by a route plan and a network plan, wherein the route plan being used to optimize travel distance based on plurality of parameters, wherein the plurality of parameter comprises geo-location of route, traffic data of the route, time of the day and behavior of the route, wherein the network plan being used to optimize number of the loading and the unloading of each package of the plurality of packages.

8. The computer implemented method as recited in claim 1, wherein the layering plan for each vehicle of the one or more vehicles being created by grouping the plurality of packages of similar characteristics together, wherein the layering plan being created by performing multiple permutations and combinations.

9. The computer implemented method as recited in claim 1, further comprising instructions for storing, at the 3-dimensional loading system with the processor, the first set of data, the second set of data, the third set of data, the delivery plan and the layering plan, wherein the storing being done in real time.

10. The computer implemented method as recited in claim 1, further comprising instruction for updating, at the 3-dimensional loading system with the processor, the first set of data, the second set of data, the third set of data, the delivery plan and the layering plan, wherein the updating being done in real time.

11. A computer system comprising:
One or more processor; and
a memory coupled to the one or more processors, the memory for storing instructions which, when executed by the one or more processors, cause the one or more processors to perform a method for a 3-dimensional loading system for loading a plurality of packages in one or more vehicles, the method comprising:
receiving, at a 3-dimensional loading system, a first set of data associated with the plurality of packages in the real time, wherein the plurality of packages being associated with the one or more sources;
collecting, at the 3-dimensional loading system, a second set of data associated with the one or more vehicles in the real time, wherein each vehicle of the one or more vehicles comprising a storage capacity;
obtaining, at the 3-dimensional loading system, a third set of data associated with delivery plan of the plurality of packages associated with the one or more sources;
analyzing, at the 3-dimensional loading system, the first set of data associated with the plurality of packages, the second set of data associated with the one more vehicle and the third set of data associated with the delivery plan of the plurality of packages, wherein the analysis being done to optimize the 3-dimensional loading system to ensure routing of the plurality of packages from the one or more sources to one or more destinations without damage;
profiling, at the 3-dimensional loading system, the plurality of packages received from the one or more sources, wherein the profiling of the plurality of packages being done to sort the plurality of packages, wherein the profiling of the plurality of packages being done based on the analysis of the first set of data, the second set of data and the third set of data;
creating, at the 3-dimensional loading system, a layering plan for each vehicle of the one or more vehicles to optimize the storage capacity of each vehicle of the one or more vehicles, wherein the layering plan being created based on the delivery plan of the plurality of packages;
loading, at the 3-dimensional loading system, the plurality of packages received from the one or more sources in the one or more vehicles, wherein the loading of the plurality of packages being performed based on the layering plan for each vehicle of the one or more vehicles; and
unloading, at a 3-dimensional loading system, the plurality of packages from the one or more vehicles at one or more destinations, wherein the unloading of the plurality of packages being based on the delivery plan.

12. The computer system as recited in claim 11, wherein the first set of data comprises one or more characteristics of each package of the plurality of packages, wherein the one or more characteristics of each package of the packages incorporate content inside each package of the plurality of packages, geometrical structure of each package of the plurality of packages, weight of each package of the plurality packages and type of material of each package of the plurality of packages.

13. The computer system as recited in claim 1, further comprising assigning, at the 3-dimensional loading system, a unique identification tag to each package of the plurality of packages wherein the unique identification tag comprises of the one or more characteristics of each package of the plurality of packages.

14. The computer system as recited in claim 1, further comprising scanning, at the 3-dimensional loading system, the unique identification tag of each package of the plurality of packages, wherein the scanning being done to validate desired loading of each package of the plurality of packages.

15. The computer system as recited in claim 1, further comprising broadcasting, at the 3-dimensional loading system, an alert notification on one or more communication devices associated with one or more loader, wherein the alert notification being broadcasted in real time.

16. The computer system as recited in claim 1, wherein the second set of data associated with one or more vehicles comprises storage capacity of each vehicle of the one or more vehicles, strength of each vehicle of the one or more vehicles and size of each vehicle of the one or more vehicles.

17. The computer system as recited in claim 1, wherein the third set of data associated with delivery plan of the plurality of packages being optimized by a route plan and a network plan, wherein the route plan being used to optimize travel distance based on plurality of parameters, wherein the plurality of parameter comprises geo-location of route, traffic data of the route, time of the day and behavior of the route, wherein the network plan being used to optimize number of the loading and the unloading of each package of the plurality of packages.

18. The computer system as recited in claim 1, wherein the layering plan for each vehicle of the one or more vehicles being created by grouping the plurality of packages of similar characteristics together, wherein the layering plan being created by performing multiple permutations and combinations.

19. The computer system as recited in claim 1, further comprising instructions for storing, at the 3-dimensional loading system, the first set of data, the second set of data, the third set of data, the delivery plan and the layering plan, wherein the storing being done in real time.

20. A computer-readable storage medium encoding computer executable instructions that, when executed by at least one processor, performs a method for a 3-dimensional loading system for loading a plurality of packages in one or more vehicles, the method comprising:
receiving, at a computing device, a first set of data associated with the plurality of packages in the real time, wherein the plurality of packages being associated with the one or more sources;
collecting, at the computing device, a second set of data associated with the one or more vehicles in real time, wherein each vehicle of the one or more vehicles having a storage capacity;
obtaining, at the computing device, a third set of data associated with delivery plan of the plurality of packages associated with the one or more sources;
analyzing, at the computing device, the first set of data associated with the plurality of packages, the second set of data associated with the one more vehicle and the third set of data associated with the delivery plan of the plurality of packages, wherein the analysis being done to optimize the 3-dimensional loading system to ensure routing of the plurality of packages from the one or more sources to one or more destinations without damage;
profiling, at the computing device, the plurality of packages received from the one or more sources, wherein the profiling of the plurality of packages being done to sort the plurality of packages, wherein the profiling of the plurality of packages being done based on the analysis of the first set of data, the second set of data and the third set of data;
creating, at the computing device, a layering plan for each vehicle of the one or more vehicles to optimize the storage capacity of each vehicle of the one or more vehicles, wherein the layering plan being created based on the delivery plan of the plurality of packages;
loading, at the computing device, the plurality of packages received from the one or more sources in the one or more vehicles, wherein the loading of the plurality of packages being performed based on the layering plan for each vehicle of the one or more vehicles; and
unloading, at the computing device, the plurality of packages from the one or more vehicles at one or more unloading places, wherein the unloading of the plurality of packages being based on the delivery plan.
